(19) United States
(12) Patent Application Publication
(10) Pub. No.: US 2005/0278368 A1
(43) Pub. Date: Dec. 15, 2005

(54) System and method for XML data integration

(76) Inventors: Michael A. Benedikt, Chicago, IL (US); Wenfei Fan, Somerset, NJ (US); Rajeev Rastogi, New Providence, NJ (US)

Correspondence Address: LAW OFFICE OF JOHN LIGON, 213 E. HIGHLAND AVENUE, P.O. BOX 281, ATLANTIC HIGHLANDS, NJ, 07716, US

(21) Appl. No.: 11/095,344

(22) Filed: Mar. 31, 2005

Related U.S. Application Data
(60) Provisional application No. 60/577,811, filed on Jun. 8, 2004.

(51) Int. Cl. G06F 17/30

(52) U.S. Cl. 707/101

(57) ABSTRACT

A framework is provided for integrating data from multiple relational sources into an XML document that both conforms to a given DTD and satisfies predefined XML constraints. The framework is based on a specification language, designated Attribute Integration Grammar (AIG), that extends a DTD by (1) associating element types with semantic attributes, (2) computing these attributes via parameterized SQL queries over multiple data sources, and (3) incorporating XML keys and inclusion constraints. The AIG uniquely operates on semantic attributes and their dependency relations for controlling context-dependent, DTD-directed construction of XML documents, and, as well as checks XML constraints in parallel with document-generation.

### RELATED APPLICATION

The invention is related to U.S. Provisional Application No. 60/577,811, filed on Jun. 8, 2004, entitled SYSTEM AND METHOD FOR INTEGRATING DATA FROM MULTIPLE RELATIONAL SOURCES, the subject matter thereof being fully incorporated by reference herein.

### FIELD OF THE INVENTION

The invention relates generally to data integration, and particularly to the integration of data from multiple relational sources into an XML document.

### BACKGROUND OF THE INVENTION

Since its creation in 1997, XML has become the primary standard for data exchange via the Internet and other data networks. However, a large number of data bases continue to maintain data in a relational format.

Data exchange applications frequently require enterprises to integrate data from different relational sources for export as an XML document. The integration of data currently residing in relational databases into an XML document requires that the data be published in XML—i.e. transformed into an XML format. The integrated XML document (as well as its transformed parts) is usually required to conform to a predefined “schema”. An XML schema consists of two parts: a type specification (typically a DTD: Document Type Definition) and a set of integrity constraints. Thus, the integrated data should both conform to the schema type and satisfy the constraints.

An exemplary case of the need for data integration as described above is commonly presented in the health care sector. There, a hospital will regularly have a need to extract patient information from its own relational data bases, convert it to an XML format, and send it to an insurance company, with the XML data generated conforming to a DTD defined by the insurance company.

While the art has recognized the need for schema directed integration, as required to accomplish data integration from relational sources into an XML document, a satisfactory method for carrying out such schema-directed integration has not been found.

### SUMMARY OF THE INVENTION

A framework is provided for integrating data from multiple relational sources into an XML document that both conforms to a given DTD and satisfies predefined XML constraints. The framework is based on a specification language, designated Attribute Integration Grammar (AIG), that extends a DTD by (1) associating element types with semantic attributes, (2) computing these attributes via parameterized SQL queries over multiple data sources, and (3) incorporating XML keys and inclusion constraints. The AIG uniquely operates on semantic attributes and their dependency relations for controlling context-dependent, DTD-directed construction of XML documents, and, as well as checks XML constraints in parallel with document-generation. In a further embodiment, cost-based optimization techniques are disclosed for efficiently evaluating AIGs, including algorithms for merging queries and for scheduling queries on multiple data sources. The invention provides a new grammar-based approach for data integration under both syntactic and semantic constraints.

### BRIEF DESCRIPTION OF THE DRAWINGS

FIG. 1 provides a schematic depiction of an exemplary XML report.

FIG. 2 provides an illustration of an Attribute Integration Grammar determined according to the method of the invention.

FIG. 3 provides an example of constraint compilation for the exemplary AIG of FIG. 2.

FIG. 4 provides an example of multi-source query decomposition for the exemplary AIG of FIG. 2.

FIG. 5 provides a schematic depiction of an AIG evaluation system according to the invention.

FIG. 6 depicts a specialized AIG developed according to the method of the invention.

FIG. 7 provides an illustrative example of a dependency graph, query merging and scheduling according to the invention.

FIG. 8 shows the steps of a scheduling algorithm used by the invention.

FIG. 9 shows the steps of a merging algorithm used by the invention.

### DETAILED DESCRIPTION OF THE INVENTION

The invention disclosed herein is directed to a method for achieving schema-directed integration in respect to the integration of data from multiple data base sources into a common document provided in the XML format. The methodology of the invention is illustrated in terms embodiments based on an integration of data in relational format into an XML formatted document. Further, the described illustrative embodiments are based on DTDs for XML types, along with keys and inclusion constraints for XML constraints, which represent the schema features most common in current practice. It should be understood, however, that the inventive concept is not limited to a particular format for the source data bases or to particular type specifications or constraints for the XML schema. In addition, while the invention is sometimes illustrated herein in terms of an integration into an XML document of data collected in a particular commercial application (i.e., data integration in the health care sector), the scope of the invention should be understood to encompass any and all applications of the schema-directed data integration method of the invention.

As indicated in the Background section, schema specifications for XML data normally make use of DTDs and XML constraints. A DTD can be represented as a tuple (or record) D=(Ele, P, r), where Ele is a finite set of element types; r is a distinguished type in Ele, called the root type; P defines the element types: for each A in Ele, P(A) is a regular expression and A→P(A) is called the production of A. To simplify the discussion herein, P(A) is considered to be of the form:
αΣ=S|ε|B₁, . . . ,Bₙ|B₁+ . . . +Bₙ|B*
where S denotes the string (PCDATA) type, E is the empty word, B is a type in Ele (referred to as a sub-element type of A), and “+”, “,” and “*” denote disjunction, concatenation and the Kleene star, respectively (here “+” is used instead of “|” to avoid confusion).

An XML document (tree) T conforms to a DTD D if the following conditions are met: (1) there is a unique node, the root, in T labeled with r; (2) each node in T is labeled either with an Ele type A, called an A element, or with S, called a text node; (3) each A element has a list of children of elements and text nodes such that they are ordered and their labels are in the regular language defined by P(A); and (4) each text node carries a string value (PCDATA) and is a leaf of the tree.

XML keys and inclusion constraints used in the invention description herein are defined as follows:

(1) Key: C(A.l→A), where C, A and l are element types such that in D, 1 is a unique string-sub-element type of A, i.e., P(l)=S and 1 is unique in P(A). In an XML tree rooted at a C element, the l-sub-element value of an A element a uniquely identifies a among all the A elements in the tree. It can be said that l is a key of A elements relative to C elements.

(2) Inclusion constraint (IC): C(B.l_{B}⊂A.l_{A}), where C, A, B, l_{A} and l_{B} are element types of D, such that l_{A} and l_{B} are of string type in P(A) and P(B), respectively.

To simplify the discussion herein, XML constraints defined with a single sub-element are considered. The same framework can be used to handle constraints in XML Schema.

As an aid to a clear understanding of the methodology of the invention the discussion hereafter of that methodology is illustrated from time to time by reference a practical example of a data exchange between an insurance company and a hospital to which that methodology would be applied. In that example, it is assumed that the hospital maintains four relational databases: one containing patient information, one indicating whether a treatment is covered by an insurance policy, one storing billing information, and one describing treatment procedures—noting that a treatment may require a procedure consisting of other treatments. The databases are specified by the following schemas (with keys underlined):

DB₁: patient information
patient(SSN, pname, policy), visitInfo(SSN, trId, date)

DB₂: insurance coverage
cover(policy, trId)

DB₃: billing information
billing(trId, price)

DB₄: treatment procedure hierarchy
treatment(trId, tname), procedure(trId1, trId2)

(Although the schema abbreviations are believed to be apparent in the context of the database descriptions, it is noted in particular that the abbreviation “trId” refers to a treatment identification.)

In this exemplary case, the hospital sends a daily report to the insurance company that includes information on patients and their treatments for that day. The insurance company requires the report to be in an XML format conforming to a fixed DTD D having the following element/sub-element hierarchy:

<!ELEMENT report (patient*)>

<!ELEMENT patient (SSN, pname, treatments, bill)>

<!ELEMENT treatments (treatment*)>

<!ELEMENT treatment (trId, tname, procedure)>

<!ELEMENT procedure (treatment*)>

<!ELEMENT bill (item*)>

<!ELEMENT item (trId, price)>

The asterisks in the above listing indicate zero or more occurrences of an element. For example, the first line indicates that a report element contains one or more patient elements.

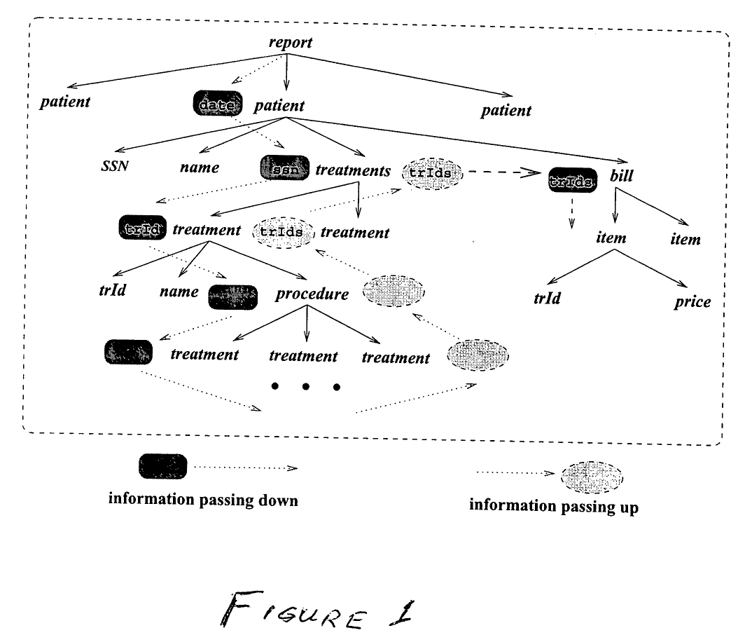

The desired XML report conforming to D is schematically depicted in FIG. 1. As indicated there, the report will contain information from the database DB₁ about patients treated on the reported day. As can be further observed from the figure, for each patient, the treatments subtree describes the treatments covered by the patient's insurance policy as well as the procedure hierarchy of each of these treatment, using the data in DB₁, DB₂ and DB₄. The bill subtree collects the price for each treatment appearing in the treatments subtree, using DB₃, for the reference of the insurance company.

The following points illustrated by the example merit note. First, the integration into the XML report requires multi-source queries—i.e., queries on multiple databases. For example, to find the treatments of a patient covered by insurance, one needs a query on both DB₁ and DB₂. Second, the element treatment is defined recursively—i.e., in terms of itself. Thus, a treatment subtree may have an unbounded depth that cannot be determined at compile-time but is rather data-driven—i.e., determined by the data in DB₄. Third, the construction of the bill subtree of a patient is context-dependent: it is determined by the trIds collected in the treatments subtree of the patient. Stated differently, because of context dependency, the bill subtree cannot be started before the treatments subtree is completed,

Indeed, for many XML-based information integration tasks, the natural flow of tree construction is not strictly top-down, but may rather require pushing information calculated during construction of one part of the tree over to another part. The arrows in FIG. 1 indicate the information flow for this example.

In addition, the insurance company imposes the following constraints on the XML reports:

Key: patient (item.trId→item)

IC: patient (treatment.trId ⊂item.trId)

The first constraint asserts that in each subtree rooted at a patient, trId is a key of item elements. That is, for any two items, if their trId sub-elements have the same value, then the two must be the same element. Stated differently, each treatment is charged only once for each patient. The second constraint is an inclusion constrain.; It requires that, under each patient, for any treatment element there must be an item such that the values of their trId sub-elements are equal. This specifies an inter-database constraint—i.e., each treatment in DB₄ must have a corresponding price entry in DB₃.

In a first aspect of the invention, the inventors have developed a language, denoted as an Attribute Integration Grammar (AIG), to specify data integration in XML. An AIG consists of two parts: a grammar and a set, Σ, of XML constraints. The AIG of the invention extends a DTD D by associating semantic attributes and semantic rules with element types. The semantic attributes, which can be either synthesized (evaluated bottom-up) or inherited (evaluated top-down), are used to pass data and control during AIG evaluation. The semantic rules compute the values of the attributes by extracting data from databases via multi-source SQL queries.

A query for computing an attribute may take other attributes as parameters. This introduces a dependency relation on attributes, and thus the power to specify sophisticated control flow within the AIG evaluation as well as context-dependent construction of elements. The constraints Σ are compiled into relations on synthesized attributes and their satisfaction checking is embedded into the attribute evaluation. As a result, the XML document is constructed via a controlled derivation from the grammar and constraints, and is thus guaranteed to both conform to D and satisfy Σ.

In a further aspect of the invention, an evaluation system is provided, based on AIGs, to integrate relational data. That system implements a variety of optimization techniques to evaluate AIGs efficiently. At compile time, it converts XML constraints into relations on synthesized attributes, reduces attribute dependencies to a minimum, and rewrites multi-source queries into single-source ones, while remaining in the AIG framework. At run time, using basic database statistics, it generates execution plans that involve scheduling and merging single-source queries to maximize parallelism among underlying relational engines and to reduce response time.

The Attribute Integration Grammar and the evaluation system of the invention are described in detail in the following sections.

I. Attribute Integration Grammars

As a general characterization of the AIGs of the invention, given a database instance I of R, an AIG extracts data from I using the SQL queries in the rules for inherited attributes, constructs an XML tree with the data directed by the productions of its DTD, and checks whether the XML tree satisfies its constraints. The synthesized attributes collect data computed at each stage and pass it to SQL queries as parameters such that the XML tree can be constructed in a context-dependent and data-driven way. The dependency relations specify an ordering on the data and control flow, which are acyclic to assure that the computation can be carried out. The inherited attribute Inh(r) of the root, referred to as the attribute of the AIG, is a global parameter that enables the computation of different XML trees for different input values. Thus an AIG can be seen as a mapping: it takes I and Inh(r) as parameters, integrates the data of I following D, and produces an XML tree that both conforms to D and satisfies constraints Σ. For example, given a date and exemplary databases DB₁, DB₂, DB₃ and DB₄ described above, the AIG σ₀ generates an XML report for the particular date by integrating the relational data.

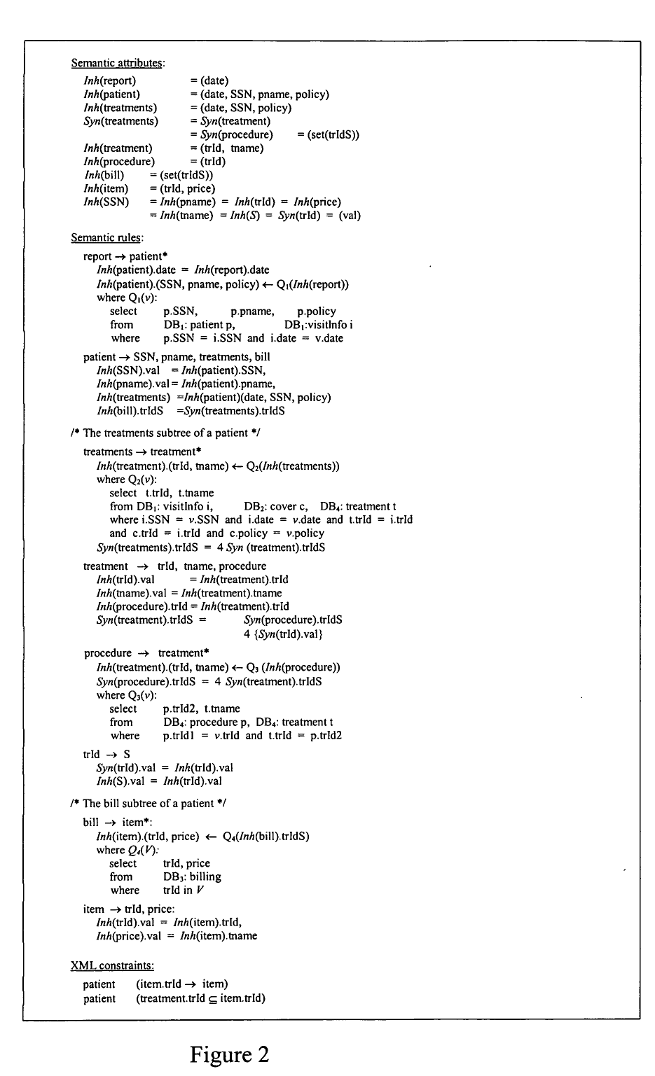

An exemplary AIG, AIG σ₀, is depicted in FIG. 2, which will be referenced from time to time in the following discussion to illustrate the rules and characteristics of AIGs developed according to the invention.

Given a DTD D=(Ele, P, r), a set Σ of XML constraints and a collection R of relational schemas, an attribute integration grammar (AIG) σ from R to D, denoted by σ: R→D, is defined to be a triple of:

1. Attributes: two disjoint tuples of attributes are associated with each A ε Ele ∪ {S}, called the inherited and synthesized attributes of A and denoted by Inh(A) and Syn(A), respectively. The terms Inh(A).x and. Syn(A).y are used to denote members, repectively, of Inh(A) and Syn(A)). Each attribute member has either a tuple type (tuple of strings) (a₁, . . . , aₖ) where the aᵢ's are distinct names, or a set type set(a₁, . . . , aₖ) denoting a set of tuples with component aᵢ's.

2. Rules: a set of semantic rules, denoted rule(p), is associated with each production p=A→α in P. rule(p) includes: (1) a rule for computing the values of Syn(A) by combining the values of Syn(Bᵢ) for each Bᵢ in α and (2) for each element type B that occurs in α, a rule for computing Inh(B) by means of an SQL query on multi-databases of R and using Ihh(A) and Syn(Bᵢ) as parameters. Here Bᵢ's are the element types other than B mentioned in α. The dependency relation of p is the transitive closure of the following relation: for any B,B′ in α, B depends on B′ iff Inh(B) is defined using Syn(B′). The dependency relation is said to be acyclic iff for any B in α, (B, B) is not in the dependency relation.

3. Constraints: XML keys and inclusion constraints of Σ are specified.

The AIG requires that the dependency relation of every production of D is acyclic, to assure that the computation can be carried out. This characteristic is illustrated in the exemplary AIG of FIG. 2, where it will be seen that the dependency relations of all the productions of σ₀ are acyclic. In that respect, note in particular that, although Inh(bill) is defined using Syn(treatments) in the production for patient, the dependency relation is not cyclic since Inh(treatments) is not defined using Syn(bill) directly or indirectly.

Given the parameter definitions above, the semantic rules for an AIG σ: R→D can now be defined in detail. Consider a production p=A→α in D with element types B₁, . . . , Bₙ in α. The notation \overline{syn(B)} is used herein to denote the vector containing all the synthesized attributes Syn(Bᵢ), and \overline{syn(Bᵢ)} is used to denote the vector of all except Syn(Bᵢ) for fixed i. Two types of functions, g and f (shown below), are used herein for computing the synthesized attribute Syn(A) and the inherited attributes Inh(Bᵢ), respectively:
g(Inh(A), {overscore (syn(B)))} Σ=(x₁, . . . , xₖ)|{x}|x|x₁ ∪. . . ∪xₖ
f(Inh(A), {overscore (syn(Bᵢ)))}Σ=(x₁, . . . , xₖ)|Q(x₁, . . . , xₖ)
where x, x₁, . . . , xₘ are members of Syn(Bⱼ) for some j (j ≠i in the second case) and Inh(A), (.) and {.} construct a tuple and a set of tuples, respectively; ∪ denotes set union, [symbol] x builds a set by collecting all the tuples in x, and Q is a multi-source SQL query over databases of R, which treats members of Inh(A) and Syn(Bⱼ) as parameters (a temporary relation is created in the database if some member is a set). Note that type compatibility is required: the type of Syn(A) must match that of g, i.e., if Syn(A) is of a tuple type (a₁, . . . , aₖ) then g must be defined using (.) and returns tuples of arity k, and if Syn(A) is of type set (a₁, . . . aₖ) then g is defined using {.}, ∪ or [symbol] and returns a set of tuples of arity k. Compatibility is similarly required for Inh(Bᵢ) and f; in particular, Inh(Bᵢ) is of a set type iff f is defined with a query. Also note that while Inh(Bᵢ) can be defined with queries to extract data from the underlying databases, Syn(A) uses simple tuple and set constructors to combine data computed previously.

Using the functions defined in the preceding paragraph, rule (p) associated with each production p=A→α can now be described.

(1) If α is S then rule(p) is defined as
Syn(A)=g(Inh(A)), Inh(S)=f(Inh(A)),
where f, g are as defined above such thatf must return a tuple of a single member, i.e., a string, which is treated as the PCDATA. This is one of the two cases where Syn(A) can be defined using Inh(A). An example of rules of this form is the one for trId→S in the AIG σ₀.
(2) If α is B₁, . . . , Bₙ, then rule(p) consists of
Syn(A)=g(\overline{syn(B)})
Inh(B₁)=f₁(Inh(A), \overline{syn(B₁)}
.
.
.
Inh(Bₙ)=f₁(Inh(A), \overline{syn(Bₙ)}
where g, fᵢ are as defined above, \overline{syn(Bᵢ)} is a list of Syn(Bⱼ)'s which does not include Syn(Bᵢ), and \overline{syn(B)} is a list of all Syn(Bⱼ)'s. This is the only case where the inherited attribute of Bᵢ can be defined with synthesized attributes of Bᵢ's siblings. For an example, see the rules for the patient production in σ₀.
(3) If α is B₁+ . . . +Bₙ, then rule(p) is defined as:
Syn(A)=case Q_{c}(Inh(A)) of
1:g₁(Syn(B₁)); . . . ; n: gₙ(Syn(Bₙ))
   (Inh(B₁), . . . , Inh(Bₙ))=case Q_{c}(Inh(A)) of
1: f₁(Inh(A)); . . . ; n:fₙ(Inh(A))
   where Q_{c} is a query that returns a value in [1, n], referred to as the condition query of the rule, and fⱼ, gᵢ are as above. If Q_{c}(Inh(A))=i, then Syn(A) and Inh(Bᵢ) are computed with gᵢ(Syn(Bᵢ)) and fᵢ(Inh(A)), respectively; otherwise they are assigned with null (or empty set, depending on their types). These capture the semantics of the nondeterministic production in a data-driven fashion.
   (4) If α is B*, then rule(p) is defined as follows:
   Syn(A)= [symbol] syn(B), Inh(B)←Q(Inh(A)),
   where Q is a query. The rule for Syn(A) collects all the synthesized attributes of its children into a set. The rule for Inh(B) introduces an iteration, which creates a B child for each tuple in the output of Q(Inh(A)) such that the child carries the tuple as the value of its inherited attribute. See the rules for the treatments production in AIG σ₀ for an example.
   (5) If α is ε, then rule(p) is defined by
   Syn(A)=g(Inh(A)),
   where g is as defined above. This is the other case where Syn(A) can be defined using Inh(A).

Using the foregoing rules, the invention then proceeds with a conceptual evaluation of an AIG σ (focused on DTD-directed integration, constraint compilation, and multi-source query decomposition. Those processes are described below, in turn.

a) Conceptual Evaluation

Given database instances I of the schema R and a value v of the attribute Inh(r) of the AIG, σ is evaluated depth-first, directed by its DTD and controlled by its dependency relation, using a stack. The root node r is first created and pushed onto the stack. For each node lv at the top of the stack, the inherited attribute value \overline{a} of lv is computed. Then the production p=A→P(A) in the DTD is found for the element type A of lv, and rule(p) is evaluated using \overline{a} as follows:

(1) If p=A→S, the first of the rule(p) definition cases is applied (i.e., Syn(A)=g(Inh(A)), Inh(S)=f(Inh(A))). A text node is created as the only child of lv with f(\vec{a}) as its PCDATA. Then, g(\overline{a}) is computed as the synthesized attribute of lv.

(2) If p=A→B₁, . . . , B_{k,}, the second of the rule(p) definition cases is applied. A node tagged with Bi is created for each i ε [1, n]. These nodes are treated as the children of lv, in the order specified by the production. Since the dependency relation of p is acyclic, there is a topological order on B₁, . . . , Bₖ, such that each Bᵢ needs only the synthesized attributes of those preceding it in the order to compute its inherited attribute, while the first one needs Inh(A) only. These nodes are pushed onto the stack in reverse-topological order, and are evaluated by substituting \vec{a} for Inh(A). After all these nodes are evaluated and popped off the stack, Syn(A) of lv is computed using the function g and the synthesized attributes of these nodes.

(3) If p=A→B₁+ . . . +Bₖ, the condition query is first evaluated, which takes Inh(A), i.e., \overline{a}, as a parameter. Based on its value, a particular Bᵢ is selected and the function for computing Inh(Bᵢ) is evaluated, a function depending on \vec{a} only. A single Bᵢ node is created as the only child of the node lv, and pushed onto the stack. The node is then evaluated. After the node is popped off the stack, Syn(A) is computed by applying gᵢ to \vec{a} and Syn(Bᵢ).

(4) If p=A→B*, the fourth of the rule(p) definition cases is applied (Syn(A)= [symbol] syn(B), Inh(B)←Q(Inh(A))). First, Inh(B) is computed. If Inh(B) is empty, then lv has no children and Syn(A) is empty; otherwise m nodes tagged with B are created as the children of lv, such that each B node carries a tuple from the set Inh(B) as its inherited attribute. The newly-created nodes are pushed onto the stack and evaluated in the same way. After all these nodes have been evaluated and popped off the stack, Syn(A) of lv is computed by collecting the synthesized attributes of these nodes into a set.

(5) If p=A→ε, the fifth of the rule(p) definition cases (Syn(A)=g(Inh(A))) is applied. g(\vec{a}) is computed as the synthesized attribute of lv.

In each of the cases, after Syn(A) of lv is computed, lv is popped off the stack, and the other nodes are evaluated until no more nodes are in the stack. At the end of the evaluation, an XML tree is created, denoted by σ (I,v).

The following should be noted. First, each node is visited only twice: it is created and pushed onto the stack, and popped off the stack after its subtree is created and evaluated; it will not be on the stack afterward. Thus the evaluation takes one-sweep. it proceeds depth-first, following an order controlled by the dependency relations instead of left-right or right-left derivation. At each node, its inherited attribute is evaluated first, then its subtree, and finally, its synthesized attributes. Second, the evaluation is data-driven: the choice of a production in the non-deterministic case and the expansion of the XML tree in the recursive case are determined by queries on the underlying relational data. Third, context-dependent construction of XML trees is supported: synthesized attributes allow control of the derivation of a subtree with data from other subtrees. Finally, each step of the evaluation expands the tree strictly following the DTD D. This yields a systematic method for DTD-directed integration.

As an example of the described DTD directed integration, consider again the AIG σ₀ of FIG. 2. Given databases DB₁, DB₂, DB₃ and DB₄ and a value v of Inh(report).date, the evaluation of σ₀ generates an XML tree T of the form depicted in FIG. 1 as follows. First, the root of T is created, tagged with report. Following the rules for the report production, Inh(patient) is computed by extracting data from DB₁ via query Q₁(v), which treats v as a constant. For each tuple in the output of Q₁(v), a patient element is created as a child of report, carrying the tuple as the value of its inherited attribute. For each patient node pt, SSN, pname, treatments and bill sub-elements are created. The first two have their S sub-elements carrying the corresponding PCDATA from the Inh(Patient) value v′ of pt. Now the dependency relation of the patient production determines that the bill subtree cannot be constructed before the treatments subtree. Thus the treatments child of pt is first evaluated by computing Q₂(v′), which is a multi-source query over three databases: DB₁, DB₂ and DB₄. Again for each tuple in the output of Q₂(v′) a treatment sub-element is created. The subtree rooted at each treatment node is generated similarly, using the rules for the treatment and procedure productions. Note that treatment is recursively defined; thus, its subtree is expanded until it reaches treatment nodes whose procedures do not consist of other treatments—i.e., when Q₃ returns the empty set over DB₄ at procedure nodes. That is, AIGs handle recursion in a data-driven fashion.

At this point Syn(procedure), Syn(treatment) and Syn(treatments) are computed bottom-up by collecting trIds from their children's synthesized attributes. Note that the value vₛ of Syn(treatments) cannot be computed before the construction of the treatments subtree is completed since the subtree has an unbounded depth. Next, vₛ is passed to the bill child of the patient node pt, and the evaluation proceeds to generate the bill subtree using the data in DB₃ and vₛ as Inh(bill). The integration is completed when all the patient subtrees are generated.

b) Constraint Compilation

An AIG is pre-processed so that (1) enforcement of its XML constraints is done in parallel with document generation, and (2) multi-source queries are rewritten into single-source ones to be executed directly by underlying relational engines. The output of this step produces a specialized AIG, an AIG that may have extra semantic rules and internal computation states. The generation of specialized AIGs is automatic: no user intervention is needed.

The method for pre-processing constraints in an AIG σ to get a specialized AIG σ′ operates as follows. The AIG σ′ extends σ with additional synthesized attributes, semantic rules and a guard construct. The synthesized attributes may have a bag type (set with duplicates), along with bag union operators “ [symbol] , [symbol] ” analogous to set operators “∪, [symbol] .” A guard captures a constraint with a boolean condition on these attributes: if the condition holds, then the evaluation proceeds, otherwise it aborts, i.e., it is terminated without success. The pre-processing step, referred to as constraint compilation, does the following:

(1) For each key k: C(A.l→A), create an additional member of type bag(lₖ) in Syn(X) for every element type X. Add semantic rules such that (i) Syn(A).lₖ is given the value of the l sub-element of A elements, (ii) for any X not equal to A, Syn(X).lₖ collects Syn(A).lₖ's below it in its subtree, excluding the l sub-element value of X; and (iii) add a guard unique(Syn(C).lₖ) for the context type C, which returns true iff Syn(C). lₖ contains no duplicates—i.e., the values of all the l sub-elements of A elements are unique within each C subtree. This automatically generates code in σ′ for checking the key.

(2) Inclusion constraint C(B.l_{B} ⊂ A.l_{A}) is treated similarly: create two additional members lₐ, l_{b} of set type in Syn(X) and add associated rules using set operators. For the type C, a guard subset(Syn(C).lₐ, Syn(C).l_{b}) returns true iff Syn(C).lₐ is contained in Syn(C).l_{b}, i.e., the inclusion relation holds within each C subtree.

The evaluation of the AIG is aborted iff any of these guards is evaluated to false, i.e., any constraint is violated.

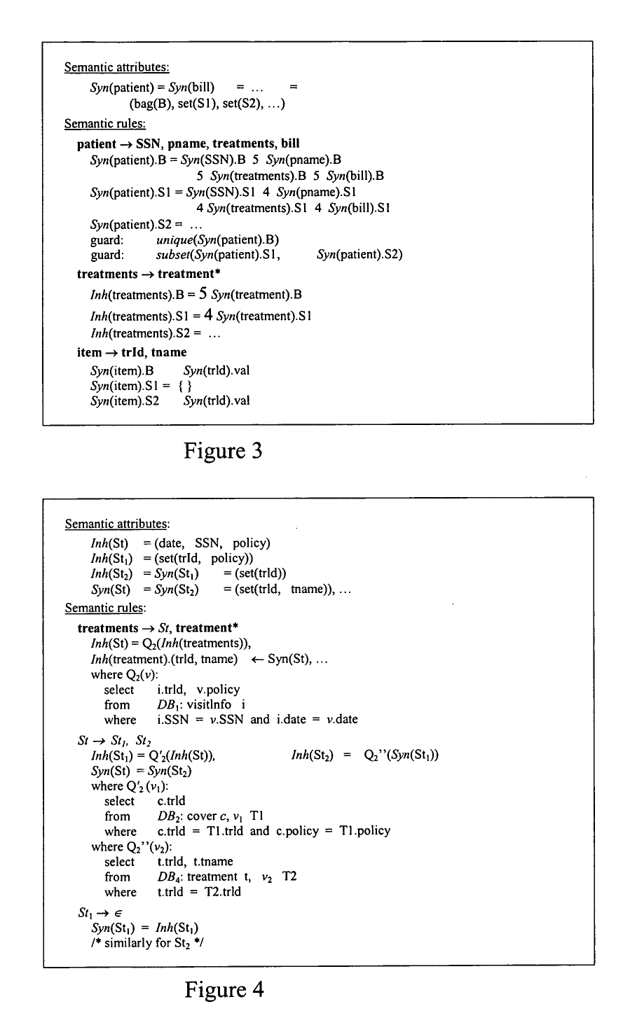

As an illustration of the constraint compilation process, the constraints of the AIG σ₀ (FIG. 2) are compiled into synthesized attributes and rules shown in FIG. 3.

Several points are noteworthy in respect to constraint compilation, and with particular reference to FIG. 3. First, the semantic rules associated with constraints can be simplified statically. For example, the rule for Syn(patient).B in FIG. 3 can be rewritten to Syn(patient).B=Syn(bill).B. These rules need not be necessarily evaluated bottom-up: the relation on attributes imposed by constraints can be used to optimize the evaluation. Indeed, if at some point during generation, a bag-valued attribute (key) is found to have duplicates, evaluation is aborted immediately. Similarly, an inclusion constraint C(B.l_{B} ⊂ A.l_{A}) suggests that B.l_{B} is passed to the rules for A such that one can check whether there is a value of B.l_{B} that is not in A.l_{A} during the computation of A.l_{A}, and vice versa. This avoids unnecessary computation.

c) Multi-source Query Decomposition

Multi-source SQL queries are decomposed according to the method of the invention through the introduction of internal states into specialized AIGs.

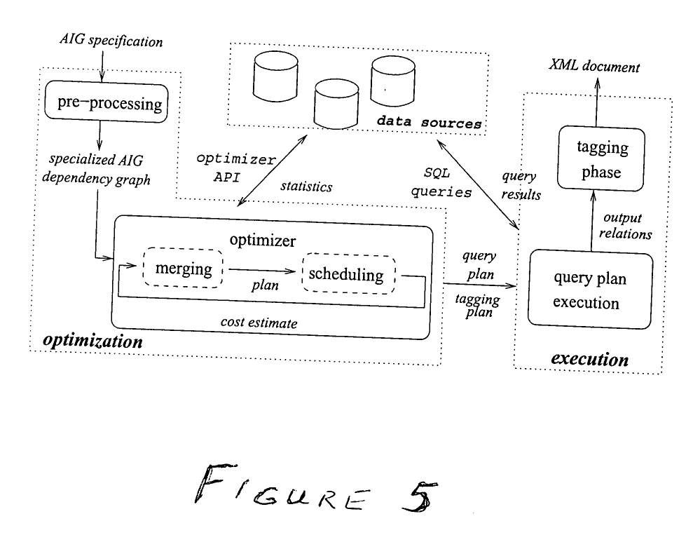

As dicussed above, the query Q₂ in the AIG σ₀ is defined on multiple databases: DB₁, DB₂ and DB₃, which may have different systems and may even reside in different sites. It is desirable to shift work from the middleware to the source relational engine as much as possible; thus the invention operates to rewrite the query into sub-queries such that each of them can be sent to and executed at the underlying relational system. To this end, a specialized AIG supports a set of states, ST, to supplement the set Ele in the DTD. A state in ST behaves like a type in Ele: it has associated attributes and semantic rules, which are evaluated in the same way. The difference is that after the integration process terminates, the nodes labeled with states in ST are removed from the resulting XML tree T That is, these ST nodes only serve for computation purpose. As an example, FIG. 4 illustrates the manner in which the specialized AIG σ′₀ rewrites Q₂ by means of internal states St, St₁ and St₂.

A specialized AIG can be viewed as a two-way tree automaton that can issue queries. It should be noted here that multi-source query decomposition according to the invention is conducted automatically. A left-deep query plan tree is first generated by means of an underlying relational optimizer, under the assumption that all the data lie on the same source. Internal states are introduced to represent the output of each node in the plan tree. The parent-child relationship follows the tree structure of the plan, and the inherited attribute and semantic rule for a given state correspond to the output attributes and operator of the associated node in the query plan.

Further note should be made of a characteristic of the restricted form of AIGs determined according to the invention that certain kinds of optimizations can be done easily at compile time. An example is copy elimination. A semantic rule in a specialized AIG is classified as a copy rule (CSR) if its righthand side makes use only of functions of the form xₖ or [symbol] x; it is referred to as a query rule (QSR) otherwise. For example, the semantic rule “Inh(treatments).trIdS= [symbol] Syn(treatment).trIdS” is a CSR. A copy chain is a maximal sequence of dependent CSRs A₁=f₁(A₀), . . . , Aₙ=fₙ(Aₙ₋₁) followed by a QSR Q that references fields of Aₙ. In copy elimination, any reference to fields of Aₙ in Q is replaced by the corresponding attributes of A₀. Note that in the resulting AIG, the semantic rule for the attributes of an element type E may now have parameters that are far away from E in the DTD. Copy-elimination can be seen to reduce dependencies among queries and thus allows more queries on different data sources to be executed in parallel.

II. AIG Evaluation

In a further embodiment of the invention, a system is provided for evaluating AIGs with a goal of optimizing the generation of the DTD-conforming XML document. Compared to traditional distributed query processing, the optimization and evaluation of AIGs present additional challenges. With AIGs, evaluation involves a set of queries that are related by inter-query dependencies (described in more detail below). Furthermore, since the output of these queries is used to drive the generation of the XML document, as queries are transformed during optimization, this relationship must be dynamically maintained. The task to manipulate and combine queries is thus heavily constrained by both inter-query and query-to-data-source dependencies, leading to a novel optimization problem.

The architecture of the AIG evaluation system of the invention is shown in FIG. 5. As illustrated in the figure, the system takes an AIG specification σ as input and evaluates it in four phases—pre-processing, optimization, execution and tagging—to produce an XML document that conforms to the DTD and satisfies the constraints embedded in AIG σ.

In the pre-processing phase, the system rewrites σ into a specialized AIG with single-source parameterized queries and relations encoding the constraints (as described above for constraint compilation and multi-source query decomposition); and performs copy elimination. The optimization phase produces a customized application, consisting of 1) a set of non-parameterized queries for each source, along with their input and output schemas; 2) a query plan giving an ordering f6r the queries among the various data sources; and 3) a tagging plan for generating the final document tree. The execution phase performs the run-time evaluation of the AIG. The query plan is executed to produce a set of output relations—a relational representation of the XML document. More specifically, at each source, the unprocessed query that is lowest in the plan's ordering is selected for execution as soon as its inputs are available. When the query is completely evaluated, its results are then shipped to every dependent site. Finally, in the tagging phase, the tagging plan is applied to these relations to produce the final output document. Note that while query plan evaluation involves both processing on the sources and shipping of data over the network, tagging is done completely within the evaluation system.

To simplify the discussion, the focus here is primarily on the case of non-recursive AIGs. As an example, a variation of the AIG σ₀ of FIG. 2 is used, by unfolding the recursion only once and assuming that the procedure leaf has no children. For non-recursive AIGs, the first three phases can be done entirely at compile time.

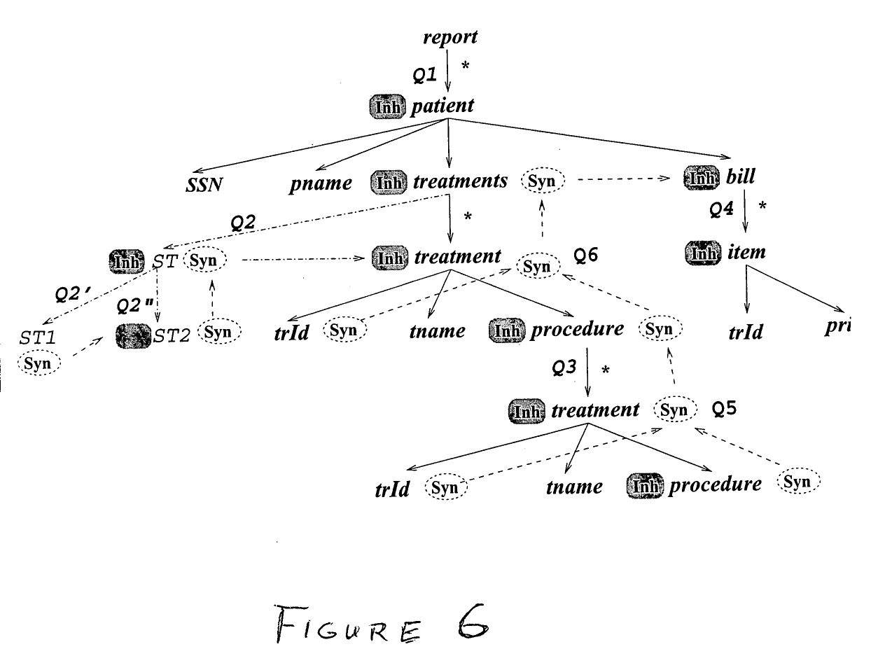

The pre-processing of the AIG yields a specialized AIG σ₀ ′ by decomposing multi-source queries, as illustrated in FIG. 4 (the rules for constraints are ignored here to simplify the discussion). The graph representation of σ₀ ′ after copy elimination is shown in FIG. 6. In this graph, edge labels represent queries for computing inherited attributes (e.g., Q2, Q2′); node labels represent queries for computing synthesized attributes (e.g., ST, ST₁); and the dashed edges indicate the flow of information. The results of the queries that compute inherited attributes are shipped to the evaluation system (which may be viewed as a special data source denoted “mediator”), cached in temporary tables, and used to construct the final XML document in the tagging phase. The synthesized attributes are computed at the mediator using the cached tables. Note that copy elimination removes the queries and attributes that are defined via copy rules (with simple projections) and are not referenced by other attributes. In the tagging phase, the values of these attributes are simply extracted from the cached tables when they are needed.

To construct the final XML tree, the queries in an AIG need to be rewritten such that the output relation of each query contains information that can uniquely identify the position of a node in the XML tree—i.e., a coding of the path from the root to the node. Furthermore, as opposed to the conceptual evaluation strategy, for each query Q that takes a single tuple of the output tmp of another query Q′ as an input, Q is converted to one that takes the entire set tmp of tuples as an input. This is done by replacing the tuple parameter in Q with the temporary table that contains the output of Q′. In the exemplary query decomposition of FIG. 4, the parameterized query Q₂(v), where v is a single tuple in Inh(patient) (the result of the query Q₁):
select i.trld, v.policy
from DB₁: visitlnfo i
where i.SSN=v.SSN and i.date=v.date
   is transformed into Q₂(Tₚₐₜᵢₑₙₜ)
select i.trld, v.policy, v.SSN
from DB₁: visitlnfo i, Tₚₐₜᵢₑₙₜ V
where i.SSN=v.SSN and i.date=v.date
   where Tₚₐₜᵢₑₙₜ is a temporary table storing Inh(patient). Note that Q₂(Tₚₐₜᵢₑₙₜ) is executed once when Tₚₐₜᵢₑₙₜ is available, instead of being executed for each tuple in Tₚₐₜᵢₑₙₜ. Note also that the output of Q₂(Tₚₐₜᵢₑₙₜ) includes an extra field, SSN, which encodes a path from the root to a patient node. This, together with the trId field, uniquely identifies the position of the ST nodes (in fact, treatment nodes) in the final document. Given this, the final XML document can be generated by simply sort-merging the cached temporary tables. This query rewriting process is done in the optimization phase via an iterative process in which the scalar parameters of query Q are replaced by temporary tables, one per output of each query that Q depends upon. The optimization phase also generates the tagging plan, which will produce the tree in a top-down fashion, associating each node of element type E with a key path in the table for Inh(E)—internal states (e.g., ST, ST₁, ST₂) in the specialized AIG are eliminated in the tagging phase.

In a further embodiment of the invention, the optimization phase operates to minimize processing costs for the AIG evaluation system and to achieve a minimal overall processing time for the schema-directed integration carried out by the AIG of the invention. In that embodiment, novel algorithms for scheduling an execution plan to minimize processing time and for merging queries to reduce communications overhead are presented, and are described in separate sections below. Before addressing those particular algorithms, a general discussion of the optimization carried out by the further embodiment is in order.

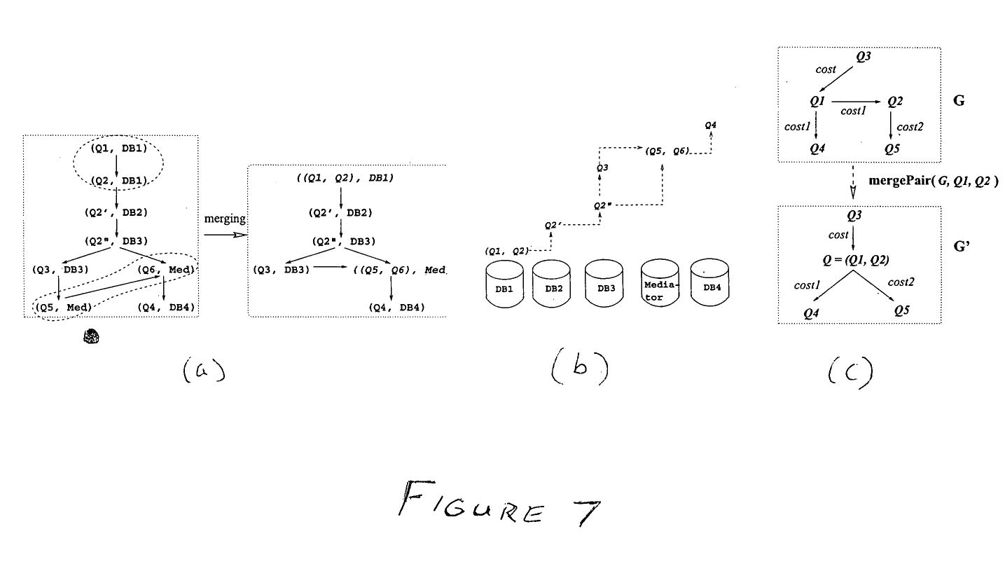

To capture the producer-consumer dependencies among the queries generated by the process above, a query dependency graph G of the AIG is provided. Such a query dependency graph will contain a node for each query, and a directed edge from a node Q₁ to node Q₂ iff the result of Q₁ is used in Q₂, denoted by Q₁→_{G} Q₂. A query dependency graph for the AIG of FIG. 6 is shown in FIG. 7(a). In this illustrative graph, each query is associated with the data source where it is evaluated. Note that G is a directed acyclic graph (“DAG”). The DAG structure reflects the fact that an AIG generally specifies sharing of a query output among multiple further queries. This is in sharp contrast both to traditional distributed query processing and to XML publishing formalisms of the art.

In respect to the impact of query plan generation in the optimization phase, a number of different factors contribute to the total execution time of an AIG specification. Notable among such factors are: (1) communication costs—data must be transferred between data sources as well as between the mediator and data sources; (2) query execution overheads—in addition to the cost of sending queries to data sources (i.e., opening a connection, parsing and preparing the statement, etc.), temporary tables may have to be created and populated with inputs to a query; (3) query execution costs—the total execution time of a query in a given data source; (4) parallel execution—queries in different sources may be executed in parallel. Consequently, an important goal of the optimizer for the AIG evaluation system is to minimize these costs and overheads by exploiting inter-query parallelism. Such optimization is further considered below.

The AIG optimizer reduces the number of queries issued to data sources by merging queries that are processed at the same source into a single, larger query. Query merging can help decrease the communication costs between the mediator and data sources, while also potentially diminishing query processing time and execution overheads. However, query merging may involve outer-joins or outer-unions which increase the arity of the query's result table and hence the output size. Furthermore, injudicious query merging may increase processing time and lead to unnecessary delay of further query executions. A cost-based query merging algorithm that iteratively applies a greedy heuristic to select pairs of queries to merge is described in the “Merging Algorithm” section below. With that algorithm, the cost function estimates the best query schedule (i.e., with the smallest total execution time) for the merged query graph.

The interaction of scheduling and merging is one of the more complex points of the optimization process. The problem of scheduling queries in the presence of DAG-like query dependencies, such as those considered here, is NP-hard, and thus an approximate scheduling algorithm is an important component of the optimization process. Such a scheduling algorithm is described in the so-named section below.

The various steps of the optimization process are illustrated in FIG. 7 and proceed as follows. Given the AIG query dependency graph G, invoke the Merge function (e.g., the Merging Algorithm described below) to merge nodes (queries) in G that lead to reduction in query evaluation cost. This involves a function for estimating the cost of a query plan (described in more detail hereafter), and a scheduling algorithm (e.g., the Scheduling Algorithm described below) for computing a good query execution ordering for G—an approximation to the optimal schedule for G. At the end of this merging phase, the final schedule is generated and submitted to the runtime engine of the evaluation system for use in the execution phase. Note that, while the AIG remains fixed during optimization, the query dependency graph G is updated in each stage of the iterative optimization.

The query dependency graph and query plan generated for this exemplary case are shown in FIGS. 7(a) and 7(b). At runtime, the evaluation system issues queries to each data source according to the query plan, and ships output tables produced by queries to sources that are dependent on these results as soon as they become available. At the end of this process, the tagging plan is applied to produce the final XML tree.

In order to estimate the cost of carrying out an AIG, information is needed about the cost of executing individual queries, shipping data, and the degree of inter-query parallelism. For the described embodiment of the invention, it is assumed that data sources provide a query costing API—i.e., for a given a query Q to be executed on a data source S, S provides estimates for both the processing time of evaluating Q, denoted herein by eval_cost(Q), and the output size (e.g., number of tuples and tuple width in bytes) of Q, denoted by size(Q). Additionally, if Q references the results of another query Q′, the API should be able to accept cost estimates of Q′ (e.g., cardinality information) as inputs in the computation of eval_cost(Q).

The evaluation system also maintains information about the costs for communicating with the various data sources. This information is used to estimate the communication time to ship results to/from data sources. The cost of transferring data of size B bytes from source S₁ to S₂ is denoted here by trans_cost(S₁, S₂, B). Note that if neither S₁ nor S₂ refers to the mediator, then the data is shipped from S₁ to S₂ via the mediator; and if S₁ and S₂ are the same source, trans_cost(S₁, S₂, B)=0.

Given the evaluation costs of each individual query, and the cost of shipping data across data sources, the total execution time can be derived from the execution plan produced by the scheduling algorithm. An execution plan P contains a schedule for each data source Sᵢ which consists of a sequence of queries πᵢ=(Q_{i,1}, Q_{i,2} . . . , Q_{i,m}) to be executed (in the given order) at Sᵢ. Note that the schedules in P have to be consistent with the partial ordering in the query dependency graph G—i.e., if Q_{i,k} is reachable from Q_{i,j} in G, then j<k. Let comp_time(Q_{i,j}) denote the completion time of the evaluation of query Q_{i,j} on data source Sᵢ. Then the response time of evaluating the execution plan P, denoted by cost(P), is simply the maximum of comp_time(Q_{i,j}) over all the queries Q_{i,j} in P. The completion time of a query Q at source Sᵢ can be computed recursively as follows:
comp_time(Q_{i,m})=eval_cost(Q_{i,m})+max{T};
where T={comp_{—}time(Q_{i,m-1})}{comp_{—}time(Q_{j,n})+trans_cost(Sⱼ, Sᵢ, size(Q_{j,n}))|Q_{j,n}→_{G}Q_{l,m}}

Thus cost(P)=max{comp_time (Q_{i,j}) |Q_{i,j} ε πᵢ, πᵢ ε P}, and can be computed in at most quadratic time using dynamic programming.

a) Scheduling Algorithm

Given a query dependency graph G, the goal of scheduling is to produce an execution plan P that is consistent with G and that minimizes the response time. Unfortunately, for any reasonable cost function on query plans, including the cost function given above, the problem of finding the optimal execution plan is NP-hard, even when there is only one data source. The inventors have developed a heuristic that gives an approximate solution for the cost function, and describe that heuristic herein.

A priority value is assigned to each query in G to reflect its “criticality”, and the queries are then sorted based on their priority values. The basic idea is to optimize the critical paths of G—i.e., the sequences of queries that affect the overall completion time. For a query Q on data source S, a path cost of Q is defined to be the cost for evaluating all the queries along a path from Q to a leaf query in the dependency graph G, and the maximum path cost is adopted as the priority value of Q, denoted by level(Q). Then, level(Q) can be computed recursively:
level(Q)=eval_{—}cost(Q)+max{level(Q′)+trans_{—}cost(S, S′, size(Q)) | Q→_{G} Q′}
where S and S′ denote, respectively, the sources where Q and Q′ are evaluated. Intuitively, Q_{i,j} is given a higher priority than Q_{i,k} if level(Q_{i,j})>level(Q_{i,k})—i.e., if the evaluation of the queries dependent on Q_{i,j} takes longer time than those depending on Q_{i,k}. This suggests the ordering of Q_{i,j} before Q_{i,k} on source Sᵢ.

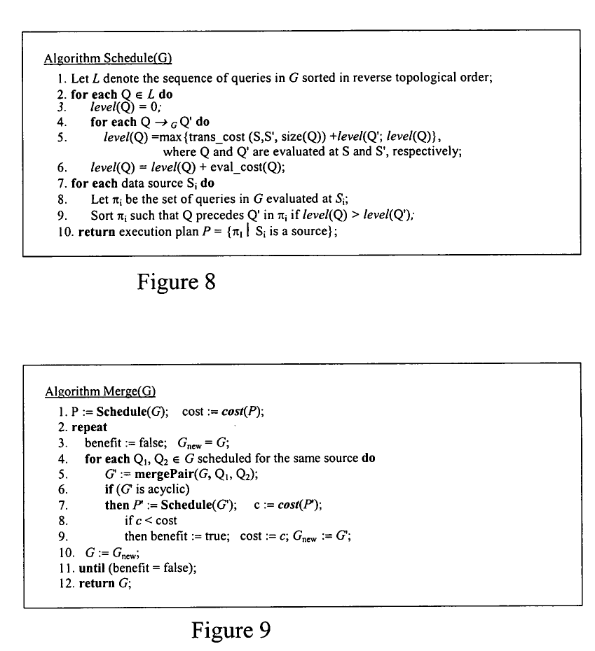

This process is described in algorithmic form in the Algorithm Schedule shown in FIG. 8. Considering the figure, steps 1 to 6 compute level(Q) for each query Q, and then steps 7 to 9 create a schedule for each data source by sorting the queries to be evaluated at the source based on level(Q). The inventors have verified that the algorithm takes at most quadratic time.

b) Merging Algorithm

This section presents a merging algorithm that selects certain queries at the same source based on cost estimates, and combines them into a single query. Query merging can reduce the data communication overhead, and may also lead to a more efficient query plan, since more optimization opportunities are offered for the data source's query optimizer. However, injudicious merging could lead to less execution parallelism since merging queries also result in their data dependencies being “merged”. Thus, query merging has to be optimized jointly with query scheduling.

The merging algorithm, which is denoted “Algorithm Merge” and depicted in FIG. 9, takes a query dependency graph G as input and iteratively derives a new query dependency graph G′ from G by determining the “best” pair of queries in G to merge at each iteration. Two queries can be merged only if they are executed at the same data source and the resultant new query dependency graph from their merging remains acyclic. The cost of the execution plan for a query dependency graph G is computed using Schedule(G) as described above. The iterative query merging process continues until no pair of queries that can be merged would lead to reduction of the execution cost.

The function mergePair derives a new dependency graph G′ from an input dependency graph G by merging two of its queries Q₁ and Q₂ into a single query Q′. More specifically, G′ is constructed from G as follows: for each query Q, if Q→_{G} Q₁ or Q→_{G} Q₂, an edge Q→_{G} Q′ is added; similarly, if there is an edge Q₁→_{G} Q or Q₂→_{G} Q, an edge Q′→_{G} Q. is added. Finally, Q₁, Q₂ and all their edges are removed from G; the resulting graph is G′, as depicted in FIG. 7(c).

The generation of a new query Q from the merging of two queries Q₁ and Q₂ will next be described. For the simple case where there are no data dependencies between Q₁ and Q₂, Q is simply the outer-union of Q₁ and Q₂. An extra “tagging” column is included in the output relation of Q to identify whether the tuples are from Q₁ or Q₂ so as to facilitate the extraction of the relevant tuples from Q at later stages. For the case where the queries Q₁ and Q₂ are related by data dependencies, e.g., Q₁→_{G} Q₂, they are merged by inlining Q₁ in Q₂, combining the common key paths.

The extraction and shipping of relevant tuples is important for reducing the communication costs. Consider the example dependency graph in FIG. 7(c), which shows the merging of two queries Q₁ and Q₂ into a new query Q. Each directed edge in the figure is labeled with the communication cost of shipping the output of one query to be used as input for another query. Note that since Q₄ needs only the output of Q₁ (similarly, Q₅ needs only the output of Q₂), the relevant tuples from Q are extracted before shipping them to the target query; consequently, the communication costs in G and G′ remain the same.

In the foregoing description of the invention, the application of the methodology of the invention was limited to non-recursive DTDs, in the interest of clarity of presentation. However, the method of the invention can readily be extended to recursive DTDs. In the presence of recursion in the DTD embedded in an AIG σ, the graph representation of σ becomes cyclic.

The extended process begins with a user-supplied estimate d of the maximum depth of the output tree, and then calculates from it a (partial) AIG by iteratively unfolding the recursive rules until all nodes that are still expandable are of depth above d. Optimization is performed at compile time on the resulting AIG σ′ as before, with the caveat that certain nodes in the dependency graph may have queries with inputs depending upon further expansion. If at runtime all queries can be evaluated, the computation of σ′ terminates and the final output relations of σ can be produced. If there are nodes Q in the dependency graph that are blocked waiting for tables that require further processing for their materialization, then the recursion is unrolled again starting from the element type in σ′ corresponding to Q: this process continues until all inputs are available, with the value of d being updated to reflect the new depth information. It is worth noting that the depth of recursive evaluation of XML documents found in practice is generally fairly small; hence a conservative estimate of the recursion depth will yield a non-recursive DTD equivalent to the original in most cases. This allows the exploitation of the cost-based estimation used in the non-recursive case, while avoiding as much as possible the need to iterate the process at runtime.

Herein, the inventors have disclosed a new method for achieving schema-directed integration of data from multiple relational data bases to a single XML document. Numerous modifications and alternative embodiments of the invention will be apparent to those skilled in the art in view of the foregoing description. For example, while the invention has been described in terms of a framework for operating on relational databases (for integration into an XML document), the same framework can be extended to integrate object-oriented, XML and other formats of data.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. A specification language for application to an integration of data from a plurality of source databases provided in a non-XML format into an XML document, the specification language operating to extend a specification type of one or more of the plurality of source databases and comprising the steps of:
associating element types of data from ones of the plurality of source databases with semantic attributes of the data and with semantic rules;
computing the semantic attributes over the plurality of databases; and
incorporating XML keys and inclusion constraints.

2. The method of claim 1 wherein the semantic attributes are determined as either inherited or synthesized attributes.

3. The method of claim 1 wherein the semantic attributes operate to pass data and control during evaluation of the specification type.

4. The method of claim 1 wherein the step of computing is carried out as a function of the semantic rules.

5. The method of claim 1 wherein the step of computing is carried out via parameterized SQL queries.

6. The method of claim 2 wherein the inclusion constraints are compiled into relations on synthesized attributes.

7. A method for integrating data from a plurality of source databases provided in a non-XML format into an XML document comprising the steps of:
providing an Attribute Integration Grammar for specifying data integration from the source databases into an XML document; and
evaluating data from the source databases using the Attribute Integration Grammar according to a defined type specification.

8. The method of claim 7 wherein the Attribute Integration Grammar is characterized by a process comprising the steps of:
associating element types of data from ones of the plurality of source databases with semantic attributes of the data and with semantic rules;
computing the semantic attributes over the plurality of databases; and
incorporating XML keys and inclusion constraints.

9. The method of claim 8 wherein the semantic attributes are determined as either inherited or synthesized attributes.

10. The method of claim 8 wherein the semantic attributes operate to pass data and control during evaluation of the specification type.

11. The method of claim 8 wherein the step of computing is carried out as a function of the semantic rules.

12. The method of claim 8 wherein the step of computing is carried out via parameterized SQL queries.

13. The method of claim 7 wherein the step of evaluating includes the step of compiling the inclusion constraints into relations on synthesized attributes.

14. The method of claim 7 wherein the step of evaluating includes the step of rewriting multi-source queries into single source queries.

15. An evaluation system operable to generate an XML document from data provided from a plurality of source databases in a non-XML format using an attibute-based specification language and XML constraints comprising:
means for carrying out converting multi-source queries on the source data into single source queries;
means for optimizing a set of queries directed to the source data;
execution means for carrying out the evaluation and generating the XML document.

16. The evaluation system of claim 15 wherein the means for optimization operates to merge queries in a manner to reduce query evaluation cost.

17. The evaluation system of claim 16 wherein the merge function is carried out according to an algorithm having the steps:

| | |
|---|---|
| 1. P := Schedule(G); | cost := cost(P); |
| 2. repeat | |
| | | |
|---|---|---|
| 3. | benefit := false; | G_{new} = G; |
| 4. | for each Q₁, Q₂ ε G scheduled for the same source do | |
|---|---|---|
| 5. | G′ := mergePair(G, Q₁, Q₂); | |
| 6. | if (G′ is acyclic) | |
| 7. | then P′ := Schedule(G′); | c := cost(P′); |
| 8.if c < cost | |
|---|---|
| 9.then benefit := true; | cost := c; G_{new} := G′; |
| 10. G := G_{new}; | |

11. until (benefit = false);
12. return G;

18. The evaluation system of claim 15 wherein the means for optimization operates to schedule query execution to minimize response time in the evaluation system.

19. The evaluation system of claim 16 wherein the schedule function is carried out according to an algorithm having the steps:
1. Let L denote the sequence of queries in G sorted in reverse
topological order;

| 2. for each Q ε L do | |
|---|---|
| 3. | level(Q) = 0; |
| 4. | for each Q → _{G} Q′ do |
| 5. | level(Q) =max {trans_cost (S,S′, size(Q)) +level(Q′; |
| | level(Q)}, |
| | where Q and Q′ are evaluated at S and S′, respectively; |
| 6. | level(Q) = level(Q) + eval_cost(Q); |
| 7. for each data source Sᵢ do | |
| 8. | Let πᵢ be the set of queries in G evaluated at Sᵢ; |
| 9. | Sort πᵢ such that Q precedes Q′ in πᵢ if level(Q) > level(Q′); |
| 10. | return execution plan P = {π_{I} \| Sᵢ is a source}; |
